(19) United States
(12) Patent Application Publication
(10) Pub. No.: US 2026/0275948 A1
(43) Pub. Date: Sep. 17, 2026

(54) FUEL INJECTOR DEVICE FOR INJECTING FUEL INTO A COMBUSTION CHAMBER OF AN INTERNAL COMBUSTION ENGINE

(71) Applicant: Cummins-Scania HPCR System, LLC, Columbus, IN (US)

(72) Inventors: Tamas Rauznitz, Columbus, IN (US); Kurt David Verkamp, Columbus, IN (US); Frank Husmeier, Columbus, IN (US); Hanumantharao Konakanchi, Columbus, IN (US)

(21) Appl. No.: 19/080,279

(22) Filed: Mar. 14, 2025

(51) Int. Cl. F02M 61/10; F02M 61/18

(52) U.S. Cl. CPC F02M 61/10; F02M 61/1853; F02M 61/1886

(57) ABSTRACT

A fuel injector device includes a nozzle injector body and a valve needle. The nozzle injector body includes an inner annular surface that defines an injector cavity connected to a sac having an injector orifice. The sac includes a sac surface that defines a sac diameter and a sac volume wherein the sac volume is defined by the sac surface, the relief portion, and the needle tip. The valve needle reciprocates in the injector cavity to control fuel delivery through the injector orifice. The valve needle includes a needle tip portion having a needle seat transition edge positioned between a needle seat portion that extends at a needle seat angle and a relief portion that extends at a relief seat angle. The relief seat angle is greater than the needle seat angle to thereby increase a sac volume when the nozzle seat portion engages the nozzle seat.

### TECHNICAL FIELD

The present application relates generally to a fuel injector for injecting fuel, and more particularly to a valve needle having a needle tip with efficiency and flow control features.

### BACKGROUND

A fuel injection system for an internal combustion engine includes a fuel injection nozzle for injecting fuel. In common rail fuel injection systems, a plurality of injectors are provided to inject fuel at high pressure into the engine cylinders of the engine. Each injector includes an injection nozzle having a valve needle which is operated by means of an actuator to move towards and away from a nozzle seat so as to control fuel delivery by the injector in an axial direction.

A nozzle seat is formed on an inner wall of the nozzle body, and a contact part is formed on the needle in the vicinity of a tip end thereof. The contact member sits on the nozzle seat and abuts against and separates from the latter to open and close the nozzle. A plurality of injection holes are formed on the inner wall of the nozzle body closer to a tip end of the nozzle body than to the nozzle seat. The fuel in the nozzle body is expelled or dispensed through the injection holes to an outside of the nozzle body when the contact part separates from the nozzle seat.

Further contributions in this area of technology are needed to increase mechanical and combustion efficiency.

### SUMMARY

Various aspects of the present application are contemplated. According to one aspect, a fuel injector device for injecting fuel into a combustion chamber of an internal combustion engine, the fuel injector device comprising: a nozzle injector body having a longitudinal axis, the nozzle injector body includes an inner annular surface that defines an injector cavity adjacent and fluidly connected to a sac, the sac includes at least one injector orifice, the inner annular surface includes a nozzle seat positioned upstream of the sac; and a valve needle configured to reciprocate in the injector cavity along the longitudinal axis to control fuel delivery through the at least one injector orifice, the valve needle includes a needle tip portion, wherein the needle tip portion includes a needle seat portion adjacent a relief portion that extends from a needle tip, wherein the needle seat portion extends at a needle seat angle about the longitudinal axis, wherein the relief portion extends at a relief seat angle about the longitudinal axis, the relief seat angle being greater than the needle seat angle such that the relief portion is configured to increase a sac volume, the sac volume being defined by the inner annular surface of the sac, the relief portion, and the needle tip, when the nozzle seat portion abuts against the nozzle seat.

In one embodiment, wherein a differential angle as determined by the difference between the relief seat angle and the needle seat angle is between 5 degrees and 45 degrees.

In one embodiment, wherein a differential angle as determined by the difference between the relief seat angle and the needle seat angle is about 12 degrees.

In one embodiment, wherein the nozzle seat extends at a nozzle seat angle that is substantially the same as the needle seat angle.

In one embodiment, the sac includes a sac surface that defines a sac diameter and a sac volume, wherein the needle tip portion includes a needle seat transition edge positioned between the relief portion and needle seat portion.

In one embodiment, the needle seat transition edge extends within the sac volume when the nozzle seat portion abuts against the nozzle seat.

In one embodiment, the nozzle seat has a seat diameter that corresponds with the nozzle seat angle, wherein the relief portion has a relief portion diameter that corresponds with the relief portion angle, the relief portion diameter is smaller than the seat diameter as measured upstream of the sac.

In one embodiment, wherein the needle tip portion is conical or spheroidal.

In one embodiment, wherein when the needle seat portion is moved away from the needle seat in a fuel injecting state, the relief portion is configured to maintain the fuel flow attached to the needle tip portion.

According to another aspect, a fuel injector device for injecting fuel into a combustion chamber of an internal combustion engine, the fuel injector device comprising: a nozzle injector body having a longitudinal axis, the nozzle injector body includes an inner annular surface that defines an injector cavity adjacent and fluidly connected to a sac, the sac includes at least one injector orifice, the sac includes a sac surface that defines a sac diameter and a sac volume wherein the sac volume is defined by the sac surface, the relief portion, and the needle tip; and

a valve needle configured to reciprocate in the injector cavity along the longitudinal axis to control fuel delivery through the at least one injector orifice, the valve needle includes a needle tip portion, wherein the needle tip portion includes a needle seat transition edge positioned between a needle seat portion and a relief portion, wherein the needle seat portion extends at a needle seat angle about the longitudinal axis, wherein the relief portion extends at a relief seat angle about the longitudinal axis, wherein the needle seat transition edge is positioned within the sac volume when the nozzle seat portion abuts against the nozzle seat.

In one embodiment, wherein a differential angle as determined by the difference between the relief seat angle and the needle seat angle is greater than 1 degree.

In one embodiment, wherein the needle tip portion includes a needle tip, wherein the relief seat angle is greater than the needle seat angle such that the relief portion is configured to increase the sac volume.

In one embodiment, wherein the needle tip extends past the at least one injector orifice when the nozzle seat portion abuts against the nozzle seat.

In one embodiment, wherein the needle tip does not extend past the at least one injector orifice when the nozzle seat portion abuts against the nozzle seat.

In one embodiment, wherein the relief seat angle is greater than the needle seat angle such that the relief portion is configured to increase a seat flow volume, the seat flow volume being defined between the relief portion and the nozzle seat as the valve needle moves away from the sac.

In one embodiment, wherein the nozzle seat extends at a nozzle seat angle that is about the same as the needle seat angle.

In one embodiment, wherein the nozzle seat has a seat diameter that corresponds with the nozzle seat angle, wherein the relief portion has a relief portion diameter that corresponds with the relief portion angle, the relief portion diameter is larger than the seat diameter as measured upstream of the sac.

In one embodiment, wherein the needle tip portion is conical or spheroidal.

In one embodiment, wherein when the needle seat portion is moved away from the needle seat in a fuel injecting state, the relief portion is configured to maintain the fuel flow attached to the needle tip portion.

In one embodiment, wherein the nozzle seat includes a nozzle seat portion that is configured to receive the needle seat portion of the valve needle.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a partial cross-sectional view of a first embodiment of a fuel injector device of the present disclosure.

FIG. 2 is an enlarged partial view of the fuel injector device of FIG. 1.

FIG. 3 is a partial cross-sectional view of the first embodiment of the fuel injector of FIG. 1 and a partial cross-sectional view of a second embodiment of a fuel injector.

FIG. 4 is an enlarged partial view of the fuel injector devices of FIG. 3.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

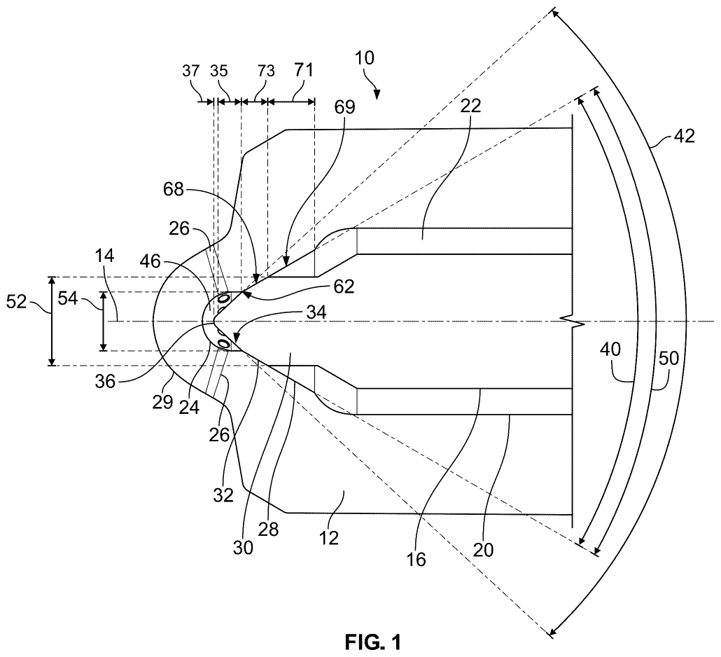

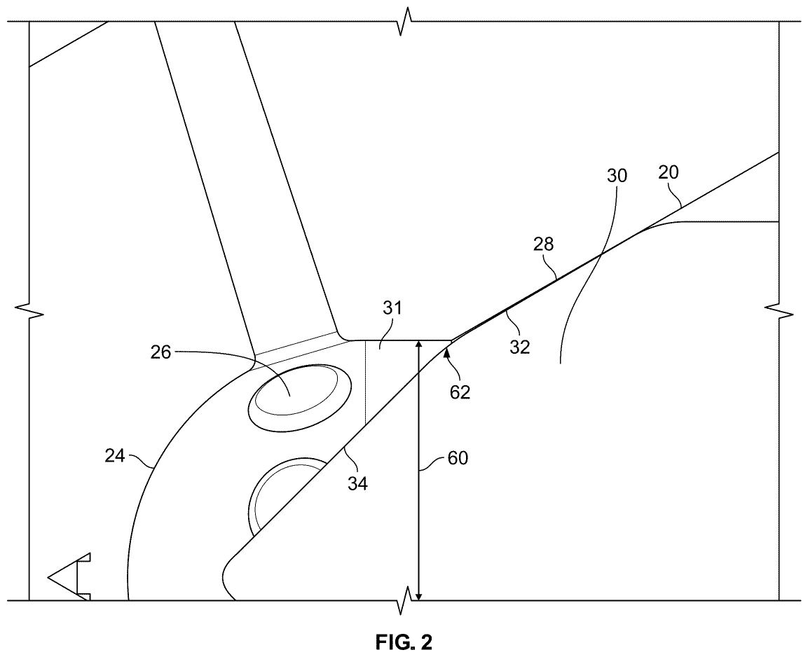

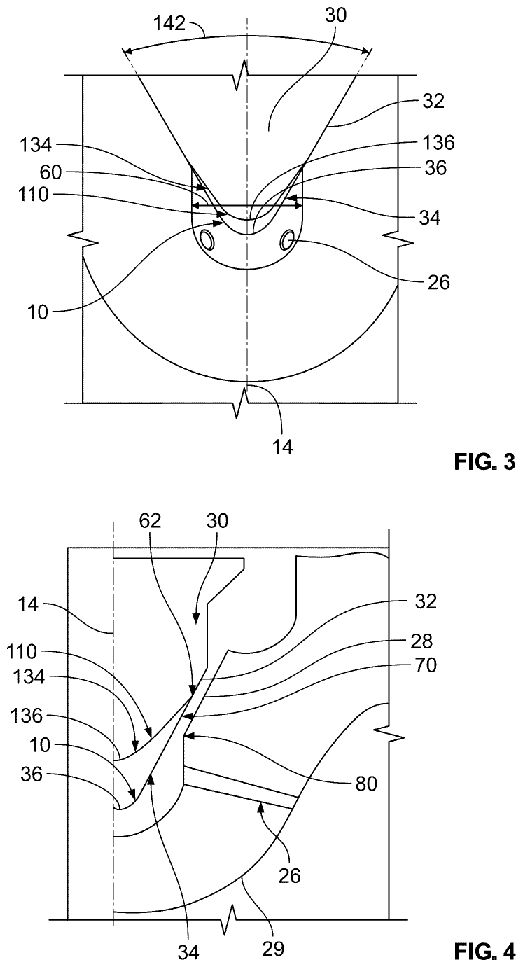

Illustrated in FIGS. 1 and 2 is a partial view of a fuel injector device 10 for injecting fuel into a combustion chamber (not illustrated) of an internal combustion engine (not illustrated). Illustrated in FIGS. 3 and 4 is a partial view of the fuel injector device 10 and a second embodiment of a fuel injector device 110. The fuel injector device 110 is the same as the fuel injector device 10 except for a differential angle and a relief portion of a needle tip portion 30 as described below. The fuel injector device 10 is described below and the description applies to the fuel injector device 110 unless noted otherwise.

The fuel injector device 10 includes a nozzle injector body 12 having a longitudinal axis 14. The fuel injector device 10 includes a valve needle 16.

The nozzle injector body 10 includes an inner annular surface 20 that defines an injector cavity 22 adjacent and fluidly connected to a sac 24. The sac 24 includes at least one injector orifice 26 and can include any number of the injector orifices 26. The inner annular surface 20 includes a nozzle seat 28 positioned upstream of the sac 24. The inner annular surface 20 includes a sac surface 31 that extends from the nozzle seat 28 to define the sac 24. The nozzle injector body 10 also includes a nozzle tip 29. The sac 24 defines a sac diameter 60 and a corresponding sac volume.

The valve needle 16 is configured to reciprocate in the injector cavity 22 along the longitudinal axis 14 to control fuel delivery through the at least one injector orifice 26. The valve needle 16 includes a needle tip portion 30. The needle tip portion 30 includes a needle seat portion 32 adjacent a relief portion 34 that extends from a needle tip 36. Similarly, the needle tip portion 30 of the fuel injector device 110 includes a relief portion 134 that extends from a needle tip 136. In one embodiment, the needle tip portion 30 has a conical shape. In another embodiment, the needle tip portion 30 has a spheroidal shape.

The needle seat portion 32 extends at a needle seat angle 40 about the longitudinal axis 14. The relief portion 34 extends at a relief seat angle 42 about the longitudinal axis 14. The relief portion 34 has a relief portion length 35 that is measured relative to the longitudinal axis 14. The needle tip 36 has a needle tip length 37 that is measured relative to the longitudinal axis 14. As illustrated in FIGS. 3 and 4, the relief portion 134 extends at a relief seat angle 142 about the longitudinal axis 14. The relief seat angles 42 and 142 are greater or larger than the needle seat angle 40 such that the relief portions 34, 134 are configured to increase a sac volume 46 when the nozzle seat portion 32 abuts against the nozzle seat 28. The sac volume 46 is defined by the inner annular surface 20 of the sac 24, the relief portion 34 (or 134), and the needle tip 36, when the nozzle seat portion 32 abuts against the nozzle seat 28. As illustrated in FIGS. 1 and 2, the needle tip 36 extends past the at least one injector orifice 26 when the nozzle seat portion 32 abuts against the nozzle seat 28. As such, the combined lengths of the relief portion length 35 and the needle tip length 37 extend over or cover the injector orifice 26. As illustrated in FIGS. 3 and 4, the needle tip 136 does not extend past the at least one injector orifice 26 when the nozzle seat portion 32 abuts against the nozzle seat 28. As such, the combined lengths of the relief portion length and the needle tip length, respectively, of the relief portion 134 and the needle tip 136 do not extend over and do not cover the injector orifice 26.

The difference between the relief seat angle 42 and the needle seat angle 40 is a differential angle. In one embodiment, the differential angle is between 5 degrees and 45 degrees. In another embodiment, the differential angle is about 12 degrees. In another embodiment, the differential angle is greater than 1 degree.

The nozzle seat 28 extends at a nozzle seat angle 50 that is substantially the same as the needle seat angle 40. In one embodiment, the nozzle seat angle 50 is within 2 degrees of the needle seat angle 40. In one embodiment, the nozzle seat 28 has a seat diameter 52 that corresponds with the nozzle seat angle 50. The relief portion 34 has a relief portion diameter 54 that corresponds with the relief portion angle 34. The seat diameter 52 is larger than the relief portion diameter 54 as measured upstream of the sac 24. The nozzle seat 28 includes a nozzle seat portion 68 that is configured to receive the needle seat portion 32 of the valve needle 16. In the illustrated embodiment in FIG. 1, the nozzle seat 28 includes a portion 69 that does not engage with the needle seat portion 32 of the valve needle 16. The portion 69 has an axial length 71 and the nozzle seat portion 68 has a nozzle seat axial length 73 wherein both of the axial length 71 and the nozzle seat axial length 73 are measured relative to the longitudinal axis 14.

Beneficially, the relief seat angle 42 is greater than the needle seat angle 50 such that the relief portion 34 is configured to increase a seat flow volume 70 wherein the seat flow volume 70 is defined between the relief portion 34 and the nozzle seat 28 as the valve needle 16 moves away from the sac 24. Beneficially, the relief seat angle 42 of the relief portion 34 is configured to maintain the fuel flow attached to the needle tip portion 30 when the needle seat portion 32 is moved away from the needle seat 28 in a fuel injecting state of the fuel injector device 10.

The needle tip portion 30 includes a needle seat transition edge 62 positioned between the relief portion 34 and needle seat portion 32. In the illustrated embodiment in FIG. 2, the needle seat transition edge 62 is positioned within the sac volume and the sac diameter 60 of the sac surface 31 when the nozzle seat portion 32 abuts against the nozzle seat 28. In another embodiment, the needle seat transition edge 62 and the relief portion 34 are positioned further downstream of the sac diameter 60 of the sac surface 31 when the nozzle seat portion 32 abuts against the nozzle seat 28. A closeness of the needle seat transition edge 62 to the sac diameter 60 could be defined as the needle seat transition edge 62 is located within 250 micrometers. In other embodiments, the needle seat transition edge 62 and the relief portion 34 are positioned upstream of the sac diameter 60 and adjacent to the inner annular surface 20 when the nozzle seat portion 32 abuts against the nozzle seat 28.

Beneficially, the differential angle between the relief seat angle 42 and the needle seat angle 40 increases a seat flow area 80 and the corresponding seat flow volume 70 rather than increasing needle lift of the valve needle 16. The unique arrangement of the differential angle between the relief seat angle 42 and the needle seat angle 40 when the nozzle seat portion 32 abuts against the nozzle seat 28 increases the effectiveness of the injector orifice 26 allowing for increased opening and closing fuel rate without an increase in the opening and closing speed of the valve needle 16. The faster opening and closing rates can result in combustion improvements and reduced greenhouse gas emissions.

Additionally, the unique arrangement prevents and reduces early flow separation of the fuel from the needle tip 36. The needle seat transition edge 62 can include a radial surface with a radius, a chamfered surface, or other curved surface to prevent flow separation of the fuel from the needle tip 36. By controlling the relief seat angle 42 of the relief portion 32 of the needle tip 36, the relative positions of the relief portion 32 and the nozzle seat portion 32, and the transition between these features, the flow is optimized to prevent and/or redirect flow separation and minimizes formation of vapor. Minimization of vapor formation protects against downstream collapse of features due to vapor formation as vapor formation can result in cavitation damage. The unique arrangement also increases mechanical and combustion efficiency while maintaining a robustness of the injector orifices 26 and protecting downstream features from cavitation damage. The unique arrangement results in the potential cavitation occurring in the injector orifices 26, rather than in the sac 24 or downstream of the injector orifices 26, to remove any potential buildup of unwanted deposits of material in the injector orifices 26.

The relief seat angle 42 of the relief portion 34 results in better cavitation behavior and better spray break up as sac pressure in the sac 24 increases. The fuel injector device 10 has better injector performance and better efficiency due to reduced pressure losses. Additional benefits include less injector orifice 26 or hole to hole variation in spray characteristics and more uniform start of fuel injection, better mass flow uniformity, and more uniform cavitation damage. Additional benefits include less sensitivity to manufacturing tolerances of the sac 24 and the injector orifices 26.

As is evident from the figures and text presented above, a variety of aspects of the present disclosure are contemplated.

Various aspects of the present application are contemplated. According to one aspect, a fuel injector device for injecting fuel into a combustion chamber of an internal combustion engine, the fuel injector device comprising: a nozzle injector body having a longitudinal axis, the nozzle injector body includes an inner annular surface that defines an injector cavity adjacent and fluidly connected to a sac, the sac includes at least one injector orifice, the inner annular surface includes a nozzle seat positioned upstream of the sac; and a valve needle configured to reciprocate in the injector cavity along the longitudinal axis to control fuel delivery through the at least one injector orifice, the valve needle includes a needle tip portion, wherein the needle tip portion includes a needle seat portion adjacent a relief portion that extends from a needle tip, wherein the needle seat portion extends at a needle seat angle about the longitudinal axis, wherein the relief portion extends at a relief seat angle about the longitudinal axis, the relief seat angle being greater than the needle seat angle such that the relief portion is configured to increase a sac volume, the sac volume being defined by the inner annular surface of the sac, the relief portion, and the needle tip, when the nozzle seat portion abuts against the nozzle seat.

In one embodiment, wherein a differential angle as determined by the difference between the relief seat angle and the needle seat angle is between 5 degrees and 45 degrees.

In one embodiment, wherein a differential angle as determined by the difference between the relief seat angle and the needle seat angle is about 12 degrees.

In one embodiment, wherein the nozzle seat extends at a nozzle seat angle that is substantially the same as the needle seat angle.

In one embodiment, the sac includes a sac surface that defines a sac diameter and a sac volume, wherein the needle tip portion includes a needle seat transition edge positioned between the relief portion and needle seat portion.

In one embodiment, the needle seat transition edge extends within the sac volume when the nozzle seat portion abuts against the nozzle seat.

In one embodiment, the nozzle seat has a seat diameter that corresponds with the nozzle seat angle, wherein the relief portion has a relief portion diameter that corresponds with the relief portion angle, the relief portion diameter is smaller than the seat diameter as measured upstream of the sac.

In one embodiment, wherein the needle tip portion is conical or spheroidal.

In one embodiment, wherein when the needle seat portion is moved away from the needle seat in a fuel injecting state, the relief portion is configured to maintain the fuel flow attached to the needle tip portion.

According to another aspect, a fuel injector device for injecting fuel into a combustion chamber of an internal combustion engine, the fuel injector device comprising: a nozzle injector body having a longitudinal axis, the nozzle injector body includes an inner annular surface that defines an injector cavity adjacent and fluidly connected to a sac, the sac includes at least one injector orifice, the sac includes a sac surface that defines a sac diameter and a sac volume wherein the sac volume is defined by the sac surface, the relief portion, and the needle tip; and a valve needle configured to reciprocate in the injector cavity along the longitudinal axis to control fuel delivery through the at least one injector orifice, the valve needle includes a needle tip portion, wherein the needle tip portion includes a needle seat transition edge positioned between a needle seat portion and a relief portion, wherein the needle seat portion extends at a needle seat angle about the longitudinal axis, wherein the relief portion extends at a relief seat angle about the longitudinal axis, wherein the needle seat transition edge is positioned within the sac volume when the nozzle seat portion abuts against the nozzle seat.

In one embodiment, wherein a differential angle as determined by the difference between the relief seat angle and the needle seat angle is greater than 1 degree.

In one embodiment, wherein the needle tip portion includes a needle tip, wherein the relief seat angle is greater than the needle seat angle such that the relief portion is configured to increase the sac volume.

In one embodiment, wherein the needle tip extends past the at least one injector orifice when the nozzle seat portion abuts against the nozzle seat.

In one embodiment, wherein the needle tip does not extend past the at least one injector orifice when the nozzle seat portion abuts against the nozzle seat.

In one embodiment, wherein the relief seat angle is greater than the needle seat angle such that the relief portion is configured to increase a seat flow volume, the seat flow volume being defined between the relief portion and the nozzle seat as the valve needle moves away from the sac.

In one embodiment, wherein the nozzle seat extends at a nozzle seat angle that is about the same as the needle seat angle.

In one embodiment, wherein the nozzle seat has a seat diameter that corresponds with the nozzle seat angle, wherein the relief portion has a relief portion diameter that corresponds with the relief portion angle, the relief portion diameter is larger than the seat diameter as measured upstream of the sac.

In one embodiment, wherein the needle tip portion is conical or spheroidal.

In one embodiment, wherein when the needle seat portion is moved away from the needle seat in a fuel injecting state, the relief portion is configured to maintain the fuel flow attached to the needle tip portion.

In one embodiment, wherein the nozzle seat includes a nozzle seat portion that is configured to receive the needle seat portion of the valve needle.

In the above description, certain relative terms may be used such as “up,” “down,” “upper,” “lower,” “horizontal,” “vertical,” “left,” “right,” “proximal,” “distal,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In some instances, the benefit of simplicity may provide operational and economic benefits and exclusion of certain elements described herein is contemplated as within the scope of the invention herein by the inventors to achieve such benefits. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fuel injector device for injecting fuel into a combustion chamber of an internal combustion engine, the fuel injector device comprising:
a nozzle injector body having a longitudinal axis, the nozzle injector body includes an inner annular surface that defines an injector cavity adjacent and fluidly connected to a sac, the sac includes at least one injector orifice, the inner annular surface includes a nozzle seat positioned upstream of the sac; and
a valve needle configured to reciprocate in the injector cavity along the longitudinal axis to control fuel delivery through the at least one injector orifice, the valve needle includes a needle tip portion, wherein the needle tip portion includes a needle seat portion adjacent a relief portion that extends from a needle tip, wherein the needle seat portion extends at a needle seat angle about the longitudinal axis, wherein the relief portion extends at a relief seat angle about the longitudinal axis, the relief seat angle being greater than the needle seat angle such that the relief portion is configured to increase a sac volume, the sac volume being defined by the inner annular surface of the sac, the relief portion, and the needle tip, when the nozzle seat portion abuts against the nozzle seat.

2. The fuel injector device of claim 1, wherein a differential angle as determined by the difference between the relief seat angle and the needle seat angle is between 5 degrees and 45 degrees.

3. The fuel injector device of claim 1, wherein a differential angle as determined by the difference between the relief seat angle and the needle seat angle is about 12 degrees.

4. The fuel injector device of claim 1, wherein the nozzle seat extends at a nozzle seat angle that is substantially the same as the needle seat angle.

5. The fuel injector device of claim 1, wherein the sac includes a sac surface that defines a sac diameter and a sac volume, wherein the needle tip portion includes a needle seat transition edge positioned between the relief portion and needle seat portion.

6. The fuel injector device of claim 5, wherein the needle seat transition edge extends within the sac volume when the nozzle seat portion abuts against the nozzle seat.

7. The fuel injector device of claim 5, wherein the nozzle seat has a seat diameter that corresponds with the nozzle seat angle, wherein the relief portion has a relief portion diameter that corresponds with the relief portion angle, the relief portion diameter is smaller than the seat diameter as measured upstream of the sac.

8. The fuel injector device of claim 1, wherein the needle tip portion is conical or spheroidal.

9. The fuel injector device of claim 1, wherein when the needle seat portion is moved away from the needle seat in a fuel injecting state, the relief portion is configured to maintain the fuel flow attached to the needle tip portion.

10. A fuel injector device for injecting fuel into a combustion chamber of an internal combustion engine, the fuel injector device comprising:
a nozzle injector body having a longitudinal axis, the nozzle injector body includes an inner annular surface that defines an injector cavity adjacent and fluidly connected to a sac, the sac includes at least one injector orifice, the sac includes a sac surface that defines a sac diameter and a sac volume wherein the sac volume is defined by the sac surface, the relief portion, and the needle tip; and
a valve needle configured to reciprocate in the injector cavity along the longitudinal axis to control fuel delivery through the at least one injector orifice, the valve needle includes a needle tip portion, wherein the needle tip portion includes a needle seat transition edge positioned between a needle seat portion and a relief portion, wherein the needle seat portion extends at a needle seat angle about the longitudinal axis, wherein the relief portion extends at a relief seat angle about the longitudinal axis, wherein the needle seat transition edge is positioned within the sac volume when the nozzle seat portion abuts against the nozzle seat.

11. The fuel injector device of claim 10, wherein a differential angle as determined by the difference between the relief seat angle and the needle seat angle is greater than 1 degree.

12. The fuel injector device of claim 10, wherein the needle tip portion includes a needle tip, wherein the relief seat angle is greater than the needle seat angle such that the relief portion is configured to increase the sac volume.

13. The fuel injector device of claim 12, wherein the needle tip extends past the at least one injector orifice when the nozzle seat portion abuts against the nozzle seat.

14. The fuel injector device of claim 12, wherein the needle tip does not extend past the at least one injector orifice when the nozzle seat portion abuts against the nozzle seat.

15. The fuel injector device of claim 10, wherein the relief seat angle is greater than the needle seat angle such that the relief portion is configured to increase a seat flow volume, the seat flow volume being defined between the relief portion and the nozzle seat as the valve needle moves away from the sac.

16. The fuel injector device of claim 10, wherein the nozzle seat extends at a nozzle seat angle that is about the same as the needle seat angle.

17. The fuel injector device of claim 16, wherein the nozzle seat has a seat diameter that corresponds with the nozzle seat angle, wherein the relief portion has a relief portion diameter that corresponds with the relief portion angle, the relief portion diameter is larger than the seat diameter as measured upstream of the sac.

18. The fuel injector device of claim 10, wherein the needle tip portion is conical or spheroidal.

19. The fuel injector device of claim 10, wherein when the needle seat portion is moved away from the needle seat in a fuel injecting state, the relief portion is configured to maintain the fuel flow attached to the needle tip portion.

20. The fuel injector device of claim 10, wherein the nozzle seat includes a nozzle seat portion that is configured to receive the needle seat portion of the valve needle.
